(19) United States
(12) Patent Application Publication
(10) Pub. No.: US 2026/0220566 A1
(43) Pub. Date: Jul. 30, 2026

(54) PATIENT-PROVIDER MATCHING, ORGANIZATIONAL TEAM MANAGEMENT, AND DIGITAL WELLNESS CHECK

(71) Applicant: Alli Connect, Inc., Snohomish, WA (US)

(72) Inventors: Colleen HILTON, Snohomish, WA (US); Richard KASPEROWSKI, Newton, MA (US)

(73) Assignee: Alli Connect, Inc., Snohomish, WA (US)

(21) Appl. No.: 19/204,323

(22) Filed: May 9, 2025

Related U.S. Application Data
(60) Provisional application No. 63/647,571, filed on May 14, 2024.
(60) Provisional application No. 63/647,455, filed on May 14, 2024.
(60) Provisional application No. 63/645,860, filed on May 11, 2024.

(51) Int. Cl. G06Q 10/0631

(52) U.S. Cl. CPC G06Q 10/063112

(57) ABSTRACT

Patient-provider matching systems harnesses the power of artificial intelligence (AI) and machine learning (ML) to optimize the therapeutic alliance in mental health treatment. By focusing on the three pillars of logistical, clinical, and human factors, the system collects comprehensive data from patients and providers to generate personalized recommendations. Patients can prioritize their needs and preferences in a provider, and the AI algorithms analyze this information to identify the most suitable matches. In addition, an Organizational Team Management system for mental health leverages software, AI, and ML technologies to enhance the efficiency and effectiveness of peer support within organizations. The system provides a streamlined platform for peer support team members to track and manage their interactions with organizational members, ensuring proper follow-up and support. Finally, a digital wellness check system combines multiple evidence-based patient-reported outcome measures (PROMs) to provide a comprehensive.

### CROSS REFERENCE

This application claims priority to the following commonly-owned US Provisional Applications: US Provisional Application No. 63/645,860, filed May 11, 2024, entitled "Patient-Provider Matching Using Artificial Intelligence"; US Provisional Applications: US Provisional Application No. 63/647,571, filed May 14, 2024, entitled "Organizational Team Management For Mental Health And Wellness Programs"; and US Provisional Application No. 63/647,455, filed May 14, 2024, entitled "Digital Wellness Check". The applications are hereby incorporated by reference in their entirety as if fully restated herein. Any conflict between the incorporated material and the specific teachings of this disclosure shall be resolved in favor of the latter. Likewise, any conflict between an art- understood definition of a word or phrase and a definition of the word or phrase as specifically taught in this disclosure shall be resolved in favor of the latter.

### TECHNICAL FIELD

This disclosure relates generally to the field of healthcare technology and, more particularly, to systems and methods for matching mental health patients with mental healthcare providers. In addition, the present disclosure relates to the field of mental health and wellness team management and, more particularly, to systems and methods for enhancing the efficiency and effectiveness of peer support teams within an organization. Furthermore, the present disclosure relates to the field of mental health assessment, and to a digital wellness check system that combines multiple evidence-based tools to accurately assess an individual's mental health and provide personalized recommendations.

### BACKGROUND

### Patient-Provider Matching

Mental health is a critical aspect of overall well-being, and access to quality mental health care is essential for individuals facing psychological challenges. However, finding the right mental health provider can be a daunting task, especially when considering the importance of the therapeutic alliance in achieving positive treatment outcomes. The therapeutic alliance, which is characterized by the creation of safety and trust in a patient-provider relationship, is a leading indicator of success in mental health treatment.

Extensive research has identified a range of factors that contribute to the development of trust and a strong therapeutic alliance between patients and providers. These factors can be categorized into three main pillars: logistical factors, clinical factors, and human factors. Logistical factors include aspects such as availability, location, and accessibility of the provider. Clinical factors encompass the provider's specialization, expertise, and treatment approach. Human factors include but are not limited to personal characteristics, therapeutic style, and cultural competence of the provider.

There is a need for an intelligent, data-driven system that can accurately match patients with healthcare providers based on a comprehensive set of factors, improving the likelihood of successful treatment outcomes and patient satisfaction.

### Organizational Team Management

A second problem faced by the healthcare industry concerns organizational team management. Peer support teams play a crucial role in promoting mental health and well-being within organizations. However, these teams often face challenges in tracking interactions, ensuring consistent follow-through, and optimizing their support strategies. Traditional methods, such as manual tracking using spreadsheets, paper reports and basic technology solutions, have limitations in terms of data collection, security, insights generation, and efficiency.

There is a need for an advanced system that streamlines peer support management, leverages data-driven insights, and incorporates artificial intelligence and machine learning techniques to enhance the effectiveness of peer support interactions and improve mental health outcomes within organizations.

### Digital Wellness Check

A third problem faced by the healthcare industry concerns wellness checks. Traditional methods for assessing mental health and wellness involve live assessments conducted by licensed medical providers, which can be time- consuming, costly, and limited in scope. These assessments often focus on a single domain of psychological concern at a time and may be influenced by the clinical setting, potentially leading to skewed reporting from patients.

There is a need for a more efficient, comprehensive, and precise method of assessing mental health and wellness that can be administered digitally, providing a global snapshot of an individual's psychological well-being while also enabling the identification of trends and risk factors within groups.

### SUMMARY

As stated above, the present disclosure encompasses three major systems. These include systems and methods for matching mental health patients with mental healthcare providers; systems and methods for enhancing the efficiency and effectiveness of peer support teams within an organization; and a digital wellness check system that combines multiple evidence-based tools to accurately assess an individual's mental health and provide personalized recommendations.

### Patient-Provider Matching

The inventive patient-provider matching system leverages artificial intelligence (AI) and machine learning (ML) techniques to connect patients with the most suitable mental health providers. The system focuses on optimizing the therapeutic alliance by considering the three pillars of logistical, clinical, and human factors in the matching process. By allowing patients to prioritize their needs and preferences in a provider, the system employs Al algorithms to generate personalized recommendations, ensuring a higher likelihood of establishing trust and safety in the patient-provider relationship.

The system collects detailed provider data, including areas of expertise, certifications, specializations, cultural competency, and therapeutic style. The Al-powered matching algorithm analyzes patient and provider data to generate personalized provider recommendations tailored to each patient's specific needs. The system also facilitates communication between patients and providers through secure messaging and appointment scheduling features. It also employs machine learning techniques to continuously improve the matching algorithm based on patient feedback and observed behaviors.

This invention offers several advantages over existing methods, including increased precision and accuracy in patient-provider matching, improved efficiency in navigating patients to appropriate care, and the ability to facilitate asynchronous communication between patients and providers.

### Organizational Team Management

The inventive Organizational Team Management system integrates software, Al, and ML technologies to streamline and enhance peer support interactions within an organization. The system provides a user-friendly platform for peer support team members to track and manage their contacts with organizational members, ensuring proper follow-up and support. An important feature of the system is the integration of Al and ML techniques to extract valuable insights from contact data and optimize peer support processes. In one embodiment, by analyzing the type of contact, reason for contact, and notes using natural language processing (NLP) and sentiment analysis, the system identifies patterns, trends, and areas for improvement. In an alternative embodiment, Live technology analyzes type of contact, reason for contact, action taken, free form notes (not necessarily NLP) and establishes a set of reminders for future action based on best practices. In addition, supervised learning algorithms, such as classification and regression, are employed to predict outcomes and recommend optimal support strategies.

The system also introduces customizable sequences and workflows for engagement, allowing peer support teams to tailor their approach based on individual needs and best practices. The system incorporates clinical-based best practice workflow templates to guide peer support interactions, ensuring consistent and evidence-based support. Another feature is the unique combination of specific fields for data collection within the system. This enables the capture of structured and unstructured data, providing a comprehensive view of peer support interactions and facilitating data-driven insights.

The advantages of the Organizational Team Management system over prior existing technology include streamlined tracking of interactions via technology, increased privacy and security through encrypted technology, and the ability to generate de-identified, aggregated data for organizational insights and proactive approaches. The system quantifies data that was previously only available through storytelling or qualitative reports, enabling data-driven decision-making and improved resource allocation.

### Digital Wellness Check

The inventive digital wellness check system integrates multiple evidence-based patient-reported outcome measures (PROMs) into a comprehensive software solution. This unique combination of PROMs, facilitated by advanced software technologies, enables the system to generate a holistic and precise evaluation of an individual's mental health and well-being. This system represents an advancement in mental health assessment, offering a unique combination of evidence-based PROMs, personalized recommendations, and advanced software capabilities. By providing accurate, efficient, and comprehensive assessments, the system empowers individuals and organizations to prioritize mental health and take proactive steps towards improving well-being.

The digital wellness check system offers several features that set it apart from prior existing technology. By deploying the assessment digitally, the system allows users to complete the PROMs in a safe and non-medical environment, reducing outside influence and potential bias in reporting. This innovative approach ensures that the collected data accurately reflects the individual's true mental state, leading to more precise and reliable assessments.

Another key advantage of the digital wellness check system is its ability to generate both quantitative and qualitative results, along with personalized recommendations tailored to each individual's assessment. The software employs sophisticated algorithms to analyze the user's responses and produce a comprehensive score that provides a clear and objective measure of their mental health. Additionally, the system generates qualitative insights and actionable recommendations, empowering individuals to take proactive steps towards improving their well-being. The system also offers significant advantages in terms of efficiency and scalability. By leveraging technology to automate the assessment process, the system drastically reduces the time required for execution compared to traditional manual methods. This increased efficiency allows organizations to assess the mental health of large populations quickly and cost-effectively, enabling timely interventions and support.

Furthermore, the unique combination of PROMs within the digital wellness check system creates a more global assessment that encompasses both psychological and physiological indicators of stress. By considering multiple dimensions of mental health, the system provides a comprehensive understanding of an individual's well-being, identifying potential risk factors and areas for improvement. This holistic approach enables organizations to develop targeted interventions and support strategies that address the specific needs of their members.

The digital wellness check system also incorporates advanced software features that enhance its functionality and usability. The system can seamlessly integrate with existing software systems, such as personnel software, records management, computer-aided dispatch (CAD), or medical records, allowing for automated assessment triggers based on specific events or criteria. This integration ensures that the system is fully aligned with organizational needs and can provide real-time insights and recommendations.

Various objects, features, aspects, and advantages of the present invention will become more apparent from the following detailed description of preferred embodiments of the invention, along with the accompanying drawings in which like numerals represent like components. The present invention may address one or more of the problems and deficiencies of the current technology discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that the accompanying drawings are not necessarily to scale since the emphasis is instead placed on illustrating the principles of the invention. The invention will now be described, by way of example, with reference to the accompanying drawings in which:

FIG. 1 is a block diagram illustrating the system architecture of the patient- provider matching system, according to an embodiment of the present disclosure.

FIG. 2 is a flow diagram illustrating the operation of the patient-provider matching system, according to an embodiment of the present disclosure.

FIGS. 3A-3F illustrate screenshots of the mobile app user interface (UI) from the consumer's perspective.

FIG. 4 depicts the software components of the inventive system, including front end, back end, database, and third-party services.

FIG. 5 is a block diagram illustrating the system architecture of the Organizational Team Management system for mental health, according to an embodiment of the present disclosure.

FIG. 6 is a flow diagram illustrating the operation of the Organizational Team Management system, according to an embodiment of the present disclosure.

FIGS. 7A-7C illustrate screenshots of the user interface (UI) of the Organizational Team Management system.

FIG. 8 is a block diagram illustrating the system architecture of the digital wellness check system, according to an embodiment of the present disclosure.

FIG. 9 is a flow diagram illustrating the operation of the digital wellness check system, according to an embodiment of the present disclosure.

FIGS. 10A-10H depict screenshots of the user interface of the digital wellness check system, illustrating the various PROMs and assessment components.

### DETAILED DESCRIPTION OF ILLUSTRATIVE EMBODIMENTS

The present invention will be understood by reference to the following detailed description, which should be read in conjunction with the appended drawings. It is to be appreciated that the following detailed description of various embodiments is by way of example only and is not meant to limit, in any way, the scope of the present invention. In the summary above, in the following detailed description, in the claims below, and in the accompanying drawings, reference is made to particular features (including method steps) of the present invention. It is to be understood that the disclosure of the invention in this specification includes all possible combinations of such particular features, not just those explicitly described. For example, where a particular feature is disclosed in the context of a particular aspect or embodiment of the invention or a particular claim, that feature can also be used, to the extent possible, in combination with and/or in the context of other particular aspects and embodiments of the invention, and in the invention generally. The terms "comprise(s)," "include(s)," "having," "has," "can," "contain(s)," and grammatical equivalents and variants thereof, as used herein, are intended to be open- ended transitional phrases, terms, or words that do not preclude the possibility of additional acts or structures. are used herein to mean that other components, ingredients, steps, etc. are optionally present. For example, an article "comprising" (or "which comprises") components A, B, and C can consist of (i.e., contain only) components A, B, and C, or can contain not only components A, B, and C but also one or more other components. The singular forms "a," "and" and "the" include plural references unless the context clearly dictates otherwise. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term "at least" followed by a number is used herein to denote the start of a range beginning with that number (which may be a range having an upper limit or no upper limit, depending on the variable being defined). For example "at least 1" means 1 or more than 1. The term "at most" followed by a number is used herein to denote the end of a range ending with that number (which may be a range having 1 or 0 as its lower limit, or a range having no lower limit, depending upon the variable being defined). For example, "at most 4" means 4 or less than 4, and "at most 40% means 40% or less than 40%. When, in this specification, a range is given as "(a first number) to (a second number)" or "(a first number)-(a second number)," this means a range whose lower limit is the first number and whose upper limit is the second number. For example, 25 to 100 mm means a range whose lower limit is 25 mm, and whose upper limit is 100 mm.

The embodiments set forth the below represent the necessary information to enable those skilled in the art to practice the invention and illustrate the best mode of practicing the invention. For the measurements listed, embodiments including measurements plus or minus the measurement times 5%, 10%, 20%, 50% and 75% are also contemplated. For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The term "substantially" means that the property is within 80% of its desired value. In other embodiments, "substantially" means that the property is within 90% of its desired value. In other embodiments, "substantially" means that the property is within 95% of its desired value. In other embodiments, "substantially" means that the property is within 99% of its desired value. For example, the term "substantially complete" means that a process is at least 80% complete, for example. In other embodiments, the term "substantially complete" means that a process is at least 90% complete, for example. In other embodiments, the term "substantially complete" means that a process is at least 95% complete, for example. In other embodiments, the term "substantially complete" means that a process is at least 99% complete, for example.

The term "substantially" includes a value that is within 10% less than or greater than the indicated value. In certain embodiments, the value is within 5% less than or greater than of the indicated value. In certain embodiments, the value is within 2.5% less than or greater than of the indicated value. In certain embodiments, the value is within 1 % less than or greater than of the indicated value. In certain embodiments, the value is within 0.5% less than or greater than of the indicated value.

The term "about" includes when value is within 10% of the indicated value. In certain embodiments, the value is within 5% of the indicated value. In certain embodiments, the value is within 2.5% of the indicated value. In certain embodiments, the value is within 1% of the indicated value. In certain embodiments, the value is within 0.5% of the indicated value.

In addition, the invention does not require that all the advantageous features and all the advantages of any of the embodiments need to be incorporated into every embodiment of the invention.

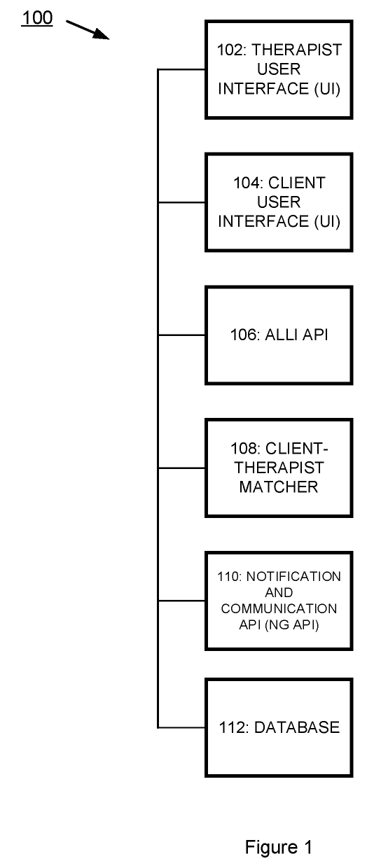

Turning now to FIGS. 1 - 10H, a brief description concerning the various components of the present invention will now be briefly discussed.

### Patient-Provider Matching Overview

The Al-powered patient-provider matching system collects comprehensive data from both patients and providers, considering the three pillars of logistical, clinical, and human factors. Patients provide information about their preferences, needs, and priorities through a user-friendly interface, while providers submit detailed profiles highlighting their expertise, specializations, and unique characteristics. The system's Al algorithms analyze this data to identify the most compatible patient-provider matches, prioritizing the factors that are most important to each individual patient.

The matching process is continually refined through closed-loop machine learning, where the system learns from patient feedback, provider assessments, and treatment outcomes to improve the accuracy and effectiveness of future recommendations. This iterative learning process ensures that the system adapts to changing needs and preferences, optimizing the therapeutic alliance for each patient-provider pair.

An important goal of the invention is to provide patient-therapist matching with an improved therapeutic alliance, also known as the working alliance or therapeutic relationship. An improved therapeutic alliance should statistically result in a longer term relationship between patient and therapist, with less churn. Patient outcomes are also improved by centering the therapeutic alliance as it is the recognized leading indicate of positive treatment outcomes. The inventive system is designed to enhance therapeutic alliance in the following ways:

Personalization: The Al-powered matching algorithm considers a range of factors, including logistical, clinical, and human factors, to create highly personalized patient-provider matches. This level of personalization helps foster a strong therapeutic relationship by ensuring that patients are paired with providers who are well-suited to address their specific needs, preferences, and communication styles.

Trust and Safety: The system is focused on matching patients with compatible providers based on their unique requirements, which helps create a foundation of trust in the therapeutic relationship.

Continuous Learning: The system's machine learning capabilities allow it to continuously learn from patient feedback, provider assessments, and treatment outcomes. This iterative learning process enables the system to refine its matching algorithm over time, adapting to changing needs and preferences to optimize the therapeutic alliance for each patient-provider pair.

Communication and Collaboration: The system's secure messaging and appointment scheduling features facilitate effective communication and collaboration between patients and providers. By streamlining these processes, the system helps build and maintain a strong therapeutic relationship, even in between sessions.

### Patient-Provider Matching System Architecture

FIG. 1 illustrates the system architecture of the patient-provider matching system 100 according to an embodiment of the present disclosure. The system 100 includes a Therapist User Interface (UI) 102, a Client User Interface (UI) 104, an Alli API 106, a Client-Therapist Matcher 108, a Notification and Communication API (NG API) 110, and a Database 112.

The Therapist UI 102 is a user-friendly interface that allows therapists to enroll in the Alli Connect network and create detailed profiles. Therapists can specify their specialties, expertise, and unique factors/dimensions that define their approach to therapy. The Therapist UI 102 enables therapists to showcase their skills and experience, making it easier for clients to find the right match.

The Client UI 104 is an intuitive interface designed for clients seeking therapy services. Clients can use this interface to specify their preferences, needs, and desired factors/dimensions in a therapist. By providing detailed information about their requirements, clients can ensure they are matched with therapists who are best suited to address their specific concerns and goals.

The Alli API 106 serves as the central hub that coordinates the activities of the Therapist UI 102, Client UI 104, Client-Therapist Matcher 108, and Database 112. It enables seamless communication and data exchange between these components, ensuring smooth and efficient operation of the entire platform. The Alli API 106 can also integrate with external information services to gather additional data points that influence the matching algorithm, enhancing the accuracy and effectiveness of the therapist-client matching process.

The Client-Therapist Matcher 108 is the core component of the Alli Connect system, employing a proprietary matching algorithm that utilizes advanced Al technology to pair clients with the most suitable therapists. The algorithm considers the factors/dimensions specified by both therapists and clients, as well as observed behaviors and success measurements. By analyzing this data, the Client-Therapist Matcher 108 identifies the best potential matches, increasing the likelihood of successful therapeutic outcomes. The Matcher 108 utilizes custom-coded proprietary Al to match clients and therapists.

The NG API 110 and Alli API 106 work together to facilitate asynchronous notifications and two-way communication between therapists, clients, and the Alli platform. These APIs enable real-time updates, appointment scheduling, and secure messaging, fostering effective collaboration and engagement. Additionally, the APIs allow for the observation of therapist and client behaviors and the measurement of matcher success, providing valuable insights for continuous improvement.

The Database 112 is a secure and robust storage system that houses comprehensive information about therapists and clients across all relevant factors/dimensions. It maintains detailed profiles, preferences, and historical data, ensuring that the matching algorithm has access to the most up-to-date and accurate information for optimal decision-making.

### Patient-Provider Matching Operation

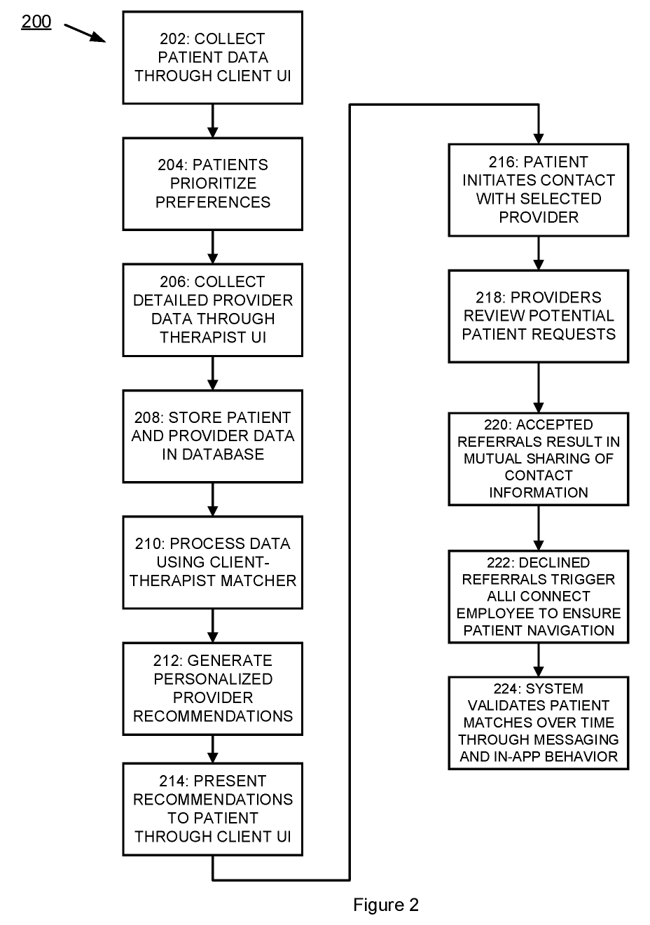

FIG. 2 illustrates the operation of the patient-provider matching system according to an embodiment of the present disclosure. The process begins with the collection of patient data through the Client UI 104 (step 202). The system captures data focusing on three principal areas: logistical factors (e.g., availability, payment method, geography), clinical factors (e.g., provider medical license type, areas of expertise, specialization), and human factors (e.g., lived experience, personality characteristics, therapeutic style).

Patients can prioritize their preferences using a drag-and-drop functionality (step 204), which directly ties into the Al-powered matching algorithm. This allows for personalized recommendations based on the patient's specific needs and priorities.

Simultaneously, the system collects detailed provider data through the Therapist UI 102 (step 206). Providers create comprehensive profiles, specifying their specialties, expertise, certifications, cultural competency, and unique factors that define their therapeutic approach.

The collected patient and provider data is stored in the Database 112 (step 208) and processed by the Client-Therapist Matcher 108 (step 210). The Al- powered matching algorithm analyzes the data, considering the specified factors/dimensions, observed behaviors, and success measurements to identify the best potential matches for each patient.

The system generates personalized provider recommendations (step 212) and presents them to the patient through the Client UI 104 (step 214). Patients can review the detailed profiles of recommended providers and initiate contact by clicking a "reach out" button (step 216), which triggers a text and email notification to the provider via the NG API 110.

Providers review potential patient requests (step 218) and can accept or decline the referral. Accepted referrals result in the mutual sharing of contact information, and the provider reaches out to the patient for scheduling (step 220). Declined referrals trigger an Alli Connect employee to ensure the patient is navigated to appropriate care (step 222).

The system validates patient matches over time through messaging with the patient and by observing the patient's in-app behavior (step 224). This feedback loop allows the Al-powered matching algorithm to learn and improve its performance continuously.

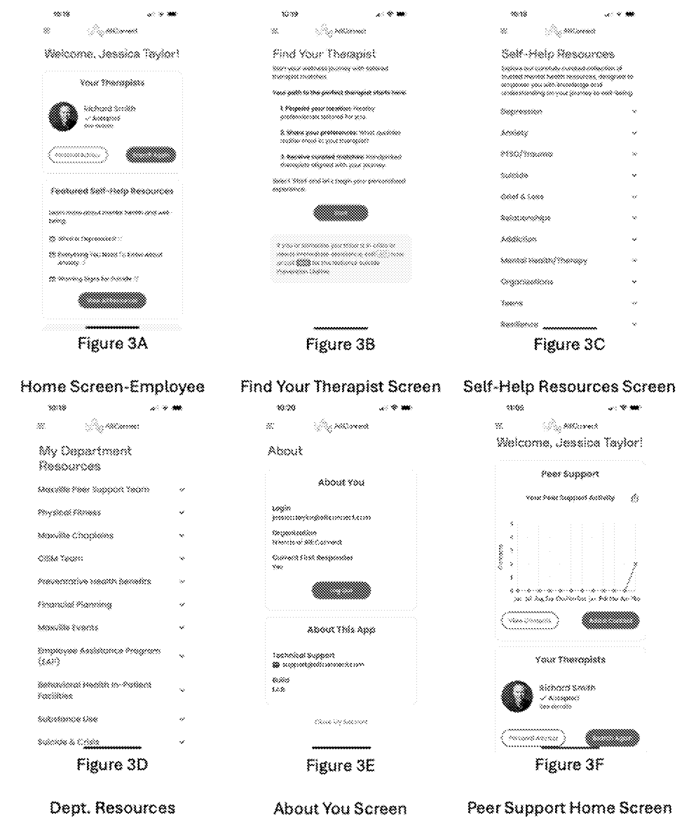

FIGS. 3A-3F illustrate screenshots of the mobile app user interface (UI) from the consumer's perspective. These screenshots showcase the various stages of the consumer onboarding process, guiding them through the steps of providing essential information and preferences to enable the Al-powered matching algorithm to generate personalized therapist recommendations.

FIG. 3A depicts the location information screen, where consumers are prompted to provide their geographic location. This information is crucial for the matching algorithm to identify therapists who are available in the consumer's area, ensuring that the recommendations are feasible and convenient for the consumer to access.

FIG. 3B shows the therapy type selection screen, prompting the user to indicate the specific type of therapy they are seeking. The UI presents a list of common therapy types, such as individual therapy, couples therapy, family therapy, or group therapy. By specifying the desired therapy type, consumers help the matching algorithm narrow down the pool of suitable therapists who specialize in the selected area.

FIG. 3C illustrates the therapist specialty selection screen, where consumers are asked to indicate the desired specialty of their ideal therapist. The UI offers a comprehensive list of specialties, such as anxiety disorders, depression, trauma, addiction, or relationship issues. By selecting one or more specialties, consumers enable the matching algorithm to identify therapists who have expertise in addressing their specific mental health concerns.

FIG. 3D represents the importance factors screen, prompting the user to indicate items that are of particular importance to them when seeking a therapist. These factors may include aspects such as the therapist's gender, age, cultural background, language proficiency, or therapeutic approach. By specifying these important factors, consumers help the matching algorithm prioritize therapists who align with their personal preferences and requirements.

FIG. 3E shows the priority selection screen, where consumers are asked to rank their priorities in terms of the factors they consider most essential in a therapist. The UI provides a list of common priorities, such as availability, location, specialization, or therapeutic style, and allows users to arrange them in order of importance. This information helps the matching algorithm weigh the various factors according to the consumer's priorities, ensuring that the recommended therapists best meet their specific needs.

FIG. 3F depicts the therapist recommendation screen, presenting the best matches available to the consumer based on the information and preferences provided in the previous screens. The screen displays a list of recommended therapists, optionally with their name, photo, specialization, and a brief description of their therapeutic approach. Consumers can tap on a therapist's profile to view more detailed information and decide whether to initiate contact or explore other recommended options.

These screenshots illustrate the step-by-step process of gathering essential information and preferences from the consumer, enabling the Al-powered matching algorithm to generate personalized therapist recommendations. The UI's design guides users through the onboarding process in a clear and intuitive manner, ensuring that they can easily provide the necessary details to find the most suitable therapist for their specific needs and preferences.

### Patient-Provider Matching Software

The software, artificial intelligence and machine learning aspects of the patient- provider matching system, centered around the Client-Therapist Matcher 108, enable the system to intelligently analyze vast amounts of data, identify compatible therapist-client pairs, and continuously learn and improve its matching performance. By leveraging advanced Al and ML techniques, the system can provide highly personalized and accurate recommendations, ultimately leading to improved patient outcomes and satisfaction.

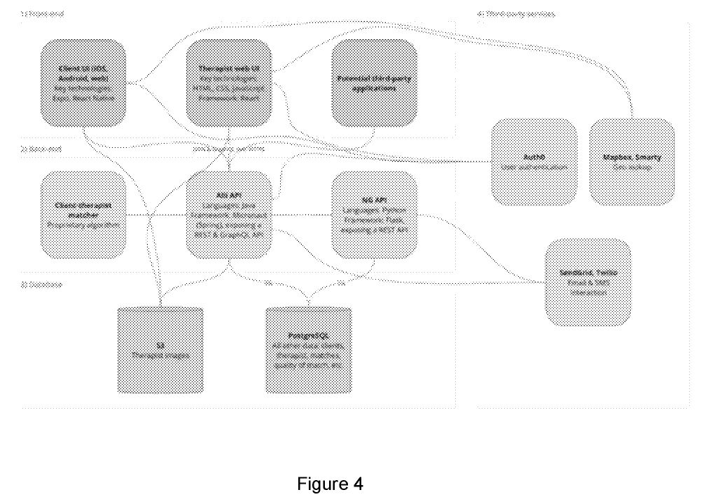

The patient-provider matching system described in the present disclosure heavily relies on artificial intelligence (AI) and machine learning (ML) techniques to achieve accurate and personalized matching between patients and healthcare providers. The core component responsible for this intelligent matching process is the Client-Therapist Matcher 108, as shown in FIGS. 1 and 4.

As shown in FIG. 4, the software components include:

Front-end components, including Client UI, Therapist web UI, and potential third-party applications.

Back-end components, including the Client-therapist matcher, APIs (Application Programming Interfaces), and NG APIs to enable users to make API calls.

Database components, including therapist images and all other necessary data.

Third-party services of authentication, security, messaging, etc.

Referring to FIG. 1, the Client-Therapist Matcher 108 employs a proprietary matching algorithm that utilizes advanced Al technology to pair clients with the most suitable therapists. This algorithm considers a wide range of factors and dimensions specified by both therapists and clients, as well as observed behaviors and success measurements, to identify the best potential matches.

The Al-powered matching algorithm operates based on a comprehensive dataset collected through the Therapist UI 102 and Client UI 104. Therapists provide detailed information about their specialties, expertise, and unique factors that define their therapeutic approach, while clients specify their preferences, needs, and desired characteristics in a therapist. This rich dataset forms the foundation for the algorithm's decision-making process.

To enhance the accuracy and effectiveness of the matching process, the Alli API 106 can integrate with external information services, either by polling or by subscribing to notifications. These external data sources provide additional data points that influence the matching algorithm, offering valuable insights and information that complement the data collected directly from therapists and clients.

The Client-Therapist Matcher 108 employs various Al and ML techniques, such as natural language processing (NLP), sentiment analysis, and pattern recognition, to analyze the collected data and identify the most compatible therapist-client pairs. The algorithm considers factors such as the therapist's areas of expertise, specializations, cultural competency, and therapeutic style, as well as the client's specific needs, preferences, and goals.

Moreover, the system utilizes ML techniques to continuously learn and improve its matching performance over time. The Notification and Communication API (NG API) 110 and Alli API 106 work together to facilitate the observation of therapist and client behaviors, as well as the measurement of matcher success. By analyzing user interactions, feedback, and outcomes, the system can refine its matching algorithm, adapting to changing needs and preferences, and optimizing its decision-making process.

The ML component of the system enables it to uncover hidden patterns, correlations, and insights that may not be apparent through manual analysis. By leveraging these insights, the Client-Therapist Matcher 108 can make more accurate and personalized recommendations, increasing the likelihood of successful therapeutic outcomes and patient satisfaction.

The Database 112 plays a crucial role in supporting the AI/ML aspects of the system by storing and managing the vast amounts of data collected from therapists, clients, and external sources. The database ensures that the matching algorithm has access to the most up-to-date and accurate information, enabling it to make informed decisions and adapt to evolving needs.

### Patient-Provider Matching Example Use Case: First Responders

First responders, including police officers, firefighters, and emergency medical technicians (EMTs), often face elevated levels of stress and trauma in their line of work. These experiences can lead to various mental health concerns, such as post-traumatic stress disorder (PTSD), anxiety, and depression. The patient-provider matching system described in the present disclosure can be particularly beneficial for connecting first responders with mental health professionals who are well-equipped to address their unique needs.

To cater to the specific requirements of first responders, the system can be customized to include additional factors and dimensions relevant to their profession. For example, the Therapist UI 102 can allow mental health providers to indicate their experience working with first responders, their familiarity with the unique challenges and stressors faced by these professionals, and their expertise in treating trauma-related disorders.

Similarly, the Client UI 104 can be adapted to include preferences and needs specific to first responders. For instance, first responders may prioritize providers who offer flexible scheduling options to accommodate their shift work, have experience working with public safety agencies, or provide teletherapy services for increased accessibility.

The Al-powered matching algorithm can then utilize these specific factors, along with the general logistical, clinical, and human factors, to generate personalized provider recommendations tailored to the needs of first responders. This targeted approach ensures that first responders are connected with mental health professionals who are best suited to support them in managing the psychological challenges associated with their demanding roles.

Furthermore, the system's secure communication and appointment scheduling features can be particularly valuable for first responders, who may have limited time and face unique privacy concerns. The asynchronous communication capabilities enable first responders to engage with their mental health providers at times that are convenient for them, without compromising their work responsibilities or personal commitments.

By providing a specialized, data-driven solution for connecting first responders with compatible mental health providers, the patient-provider matching system can help to improve access to care, reduce barriers to seeking support, and ultimately contribute to the well-being and resilience of these essential workers. This use case demonstrates the adaptability and potential of the system to address the unique mental health needs of specific populations, such as first responders, who face distinct challenges and require tailored support.

### Patient-Provider Matching Alternative Embodiments and Machine Learning Approaches

The patient-provider matching system described in the present disclosure offers a solid foundation for utilizing Al and ML techniques to optimize the therapeutic alliance in mental health treatment. However, there are various alternative embodiments and approaches that could be explored to further enhance the system's performance, scalability, and adaptability. This section discusses some of these alternative embodiments, with a focus on different machine learning approaches, including MLOps (Machine Learning Operations).

### Ensemble Learning

One alternative approach to the current Al-powered matching algorithm is to employ ensemble learning techniques. Ensemble learning combines multiple machine learning models to improve the overall predictive performance and robustness of the system. Instead of relying on a single algorithm, the Client- Therapist Matcher 108 could utilize a combination of models, such as decision trees, support vector machines, and neural networks, to generate more accurate and diverse recommendations.

Ensemble methods, such as bagging, boosting, and stacking, can help reduce overfitting, improve generalization, and handle complex data patterns. By leveraging the strengths of different models and aggregating their predictions, the system can provide more reliable and robust patient-provider matches.

### Transfer Learning

Another alternative approach is to incorporate transfer learning techniques into the matching algorithm. Transfer learning allows the system to leverage knowledge gained from one task or domain and apply it to a related task or domain. In the context of patient-provider matching, transfer learning can be particularly useful when dealing with limited or imbalanced data.

For example, the system could be pre-trained on a large dataset of patient- provider interactions from a related domain, such as general healthcare, before being fine-tuned on the specific mental health dataset. This approach can help the algorithm learn valuable features and patterns from the related domain, improving its performance and reducing the need for extensive labeled data in the target domain.

### Federated Learning

Federated learning is an emerging paradigm in machine learning that enables multiple parties to collaborate on training a model without sharing raw data. This approach is particularly relevant in the healthcare domain, where data privacy and security are of utmost importance.

In a federated learning setup, the patient-provider matching system could be deployed across multiple mental health institutions or practices, each with its own local data. Instead of centralizing the data, the institutions would train local models on their respective datasets and share only the model updates with a central server. The central server aggregates the updates and generates a global model, which is then distributed back to the local institutions.

This decentralized approach allows the system to learn from a diverse range of data sources while preserving data privacy and minimizing the risk of data breaches. Federated learning can also help address issues related to data silos and enable collaboration among different healthcare providers.

### MLOps (Machine Learning Operations)

MLOps is an emerging practice that focuses on the operational aspects ofdeploying, monitoring, and maintaining machine learning models in production environments. Incorporating MLOps principles into the patient-provider matching system can help ensure the system's reliability, scalability, and continuous improvement.

Some key aspects of MLOps that could be applied to the system include:
a. Model Versioning and Tracking: Implementing a versioning system to track different iterations of the matching algorithm, allowing for easy rollback and comparison of model performance over time.
b. Automated Model Deployment: Streamlining the process of deploying trained models into production, enabling faster updates and reducing manual intervention.
c. Monitoring and Logging: Implementing comprehensive monitoring and logging mechanisms to track the system's performance, detect anomalies, and identify areas for improvement.
d. Continuous Integration and Continuous Deployment (Cl/CD): Establishing a Cl/CD pipeline to automate the build, test, and deployment processes, ensuring that updates to the matching algorithm are thoroughly validated before being pushed to production.
e. Model Explainability and Interpretability: Incorporating techniques to make the matching algorithm more transparent and interpretable, allowing stakeholders to understand the factors influencing the recommendations and fostering trust in the system.

By adopting MLOps practices, the patient-provider matching system can become more robust, scalable, and adaptable to changing requirements and data patterns. This approach can also help bridge the gap between the development and production environments, ensuring that the system delivers consistent and reliable performance in real-world settings.

### Reinforcement Learning

Reinforcement learning (RL) is a type of machine learning that focuses on learning optimal decision-making strategies through interaction with an environment. In the context of patient-provider matching, RL could be used to continuously refine the matching algorithm based on feedback and outcomes. Instead of relying solely on supervised learning, where the algorithm learns from labeled examples, RL allows the system to learn from its own actions and the resulting rewards or penalties. The system could define a reward function based on factors such as patient satisfaction, therapeutic alliance, and treatment outcomes. The matching algorithm would then learn to make decisions that maximize the cumulative reward over time.

RL can help the system adapt to changing patient preferences, provider availability, and treatment effectiveness. By exploring different matching strategies and learning from their consequences, the algorithm can continuously improve its decision-making process and provide more personalized and effective recommendations.

### Hybrid Approaches

Another alternative embodiment is to combine multiple machine learning approaches to create a hybrid system. For example, the patient-provider matching system could leverage a combination of supervised learning, unsupervised learning, and reinforcement learning techniques to generate more comprehensive and accurate recommendations.

Supervised learning could be used to learn from labeled examples of successful patient-provider matches, while unsupervised learning could help uncover hidden patterns and similarities among patients and providers. Reinforcement learning could be employed to continuously refine the matching algorithm based on feedback and outcomes.

A hybrid approach can take advantage of the strengths of different machine learning paradigms and provide a more holistic and adaptive solution to patient- provider matching. By combining various techniques, including generative Al / LLMs, the system can become more resilient to data limitations, capture complex relationships, and adapt to evolving needs and preferences.

The alternative embodiments and machine learning approaches discussed in this section highlight the potential for further enhancing the patient-provider matching system described in the present disclosure. By exploring techniques such as ensemble learning, transfer learning, federated learning, MLOps, reinforcement learning, and hybrid approaches, the system can become more robust, scalable, and adaptable to the dynamic nature of mental health treatment. These approaches can help address challenges related to data privacy, limited labeled examples, changing patient preferences, and the need for continuous improvement. By incorporating these techniques, the patient- provider matching system can provide more accurate, personalized, and effective recommendations, ultimately leading to better therapeutic alliances and improved mental health outcomes.

### Patient-Provider Matching Conclusion

The patient-provider matching system described in the present disclosure offers a novel and intelligent approach to connecting patients with the most suitable healthcare providers, particularly in the domain of mental health services. By leveraging Al and ML technologies, along with comprehensive patient and provider data, the system achieves an elevated level of precision and personalization in the matching process.

The system's user-friendly interfaces, secure communication channels, and continuous learning capabilities contribute to improved patient outcomes, increased efficiency, and enhanced overall satisfaction for both patients and providers. As the system evolves and learns from user interactions and feedback, it has the potential to revolutionize the way patients access and engage with specialized healthcare services, ultimately leading to better health more efficient healthcare system.

The Al-powered matching algorithm, which considers a wide range of factors and dimensions, ensures that patients are matched with providers who are best equipped to address their specific needs and preferences. This level of personalization is essential for fostering strong therapeutic relationships and maximizing the effectiveness of treatment.

Moreover, the system's ability to facilitate asynchronous communication and appointment scheduling streamlines the process of connecting patients with providers, reducing administrative burdens and wait times. This increased efficiency allows providers to focus more on delivering high-quality care and less on logistical challenges.

As the system continues to collect data and refine its matching algorithm, it has the potential to uncover valuable insights into patient needs, provider effectiveness, and treatment outcomes. These insights can inform the development of new therapeutic approaches, guide resource allocation, and contribute to the overall advancement of mental healthcare.

In conclusion, the patient-provider matching system presented in this disclosure represents a significant step forward in the application of Al and ML technologies to improve the accessibility, efficiency, and effectiveness of mental healthcare services. By empowering patients to find the most suitable providers and enabling providers to connect with patients who can benefit most from their expertise, this innovative system has the potential to transform the landscape of mental healthcare delivery.

### Organizational Team Management Overview

The Organizational Team Management system for mental health represents a significant advancement in the field of peer support within organizations. By leveraging software, Al, and ML technologies, the system enhances the efficiency and effectiveness of peer support interactions, ultimately improving mental health outcomes and promoting well-being within the organization.

The system provides a streamlined platform for peer support team members to track and manage their contacts with organizational members. Through a user- friendly interface, team members can input contact details, including the date, type of contact, reason for contact, and notes. This information is securely stored in an encrypted database, ensuring privacy and confidentiality.

One of the important innovations of the system is the integration of Al and ML techniques. The Al-powered Insights and Efficiency module collects and analyzes contact data to extract valuable insights and optimize peer support processes. By employing NLP and sentiment analysis, the system identifies patterns, trends, and areas for improvement. Supervised learning algorithms are used to predict outcomes and recommend optimal support strategies, enabling data-driven decision-making and personalized support.

The system introduces customizable sequences and workflows for engagement, allowing peer support teams to adapt their approach based on individual needs and best practices. Clinical-based best practice workflow templates are incorporated to guide peer support interactions, ensuring consistent and evidence-based support across the organization.

The unique combination of specific fields for data collection within the system enables the capture of structured and unstructured data, providing a comprehensive view of peer support interactions. This data is quantified and analyzed, generating insights that were previously only available through storytelling or qualitative reports.

The Organizational Team Management system offers several advantages over prior existing technology. It streamlines the tracking of interactions via technology, reducing manual effort and improving efficiency. The use of encrypted technology enhances privacy and security, protecting sensitive information. The system generates de-identified, aggregated data, providing organizational insights for proactive approaches and resource allocation.

In sum, the Organizational Team Management system for mental health and wellness programs represents a transformative solution for enhancing peer support within organizations. By integrating software, Al, and ML technologies, customizable workflows, best practice templates, and unique data collection fields, the system empowers peer support teams to provide personalized, data- driven support. The advantages of streamlined tracking, increased privacy and security, and quantified data insights make this system a valuable tool for improving mental health outcomes and promoting well-being within organizations.

### Organizational Team Management System Architecture

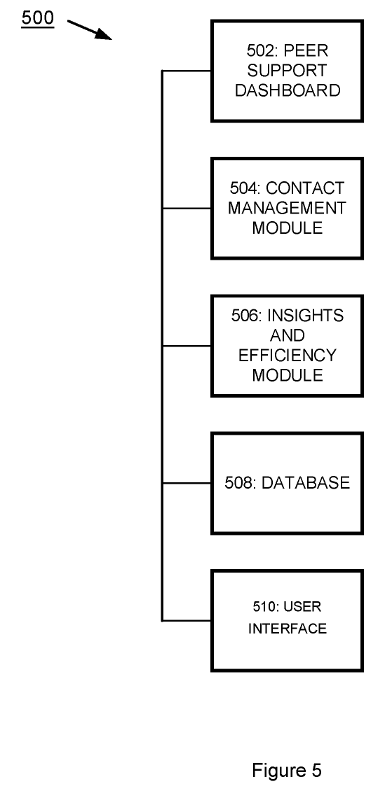

FIG. 5 illustrates the system architecture of the Organizational Team Management system 500 according to an embodiment of the present disclosure. The system 500 includes a Peer Support Dashboard 502, a Contact Management module 504, an Al-powered Insights and Efficiency module 506, a Database 508, and a User Interface 510.

The Peer Support Dashboard 502 provides an overview of peer support activities, including the number of contacts per month, upcoming contacts, and featured self-help resources. It retrieves and displays data from the Database 508, allowing peer support team members to view and manage their contacts and access relevant resources. The Peer Support Dashboard 502 enables peer support team members to efficiently track and organize their interactions with organizational members.

The Contact Management module 504 allows peer support team members to view, add, and manage contacts with organizational members. It provides a user-friendly interface for entering contact details, including the date, type of contact, reason for contact, and notes. The Contact Management module 504 stores contact information securely in the Database 508, facilitating the tracking and documentation of peer support interactions and ensuring proper follow-up and support.

The Al-powered Insights and Efficiency module 506 integrates artificial intelligence (AI) and machine learning (ML) techniques to extract key insights from contact data and optimize peer support processes. It collects and analyzes contact data, including the type of contact, reason for contact, and notes, utilizing natural language processing (NLP) and sentiment analysis to identify patterns, trends, and areas for improvement. The module 506 employs supervised learning algorithms, such as classification and regression, to predict outcomes and recommend optimal support strategies. By providing data-driven insights, identifying high-priority cases, and suggesting personalized support approaches, the Al-powered Insights and Efficiency module 506 enhances the effectiveness of peer support.

The Database 508 serves as a secure and centralized repository for storing contact data, user information, and other relevant data. It ensures data privacy and confidentiality while providing efficient access to the stored information for various modules and components of the system.

The User Interface 510 is a web-based interface that allows peer support team members and organizational members to interact with the Organizational Team Management system. It provides a user-friendly and intuitive interface for accessing the Peer Support Dashboard 502, managing contacts through the Contact Management module 504, and viewing Al-generated insights and recommendations.

### Organizational Team Management Operation

As described below, the inventive system provides a streamlined, confidential way for peer teams to track their interactions with members. Data is gathered on number, type, and several other fields of information to quantify effectiveness of peer teams as a whole and individual peer team members. Peer team members can be assigned and deployed to provide support, creating sequences that align with best practices to ensure consistent follow through. Organizational members can request a contact of support and be matched to the right peer member for their unique needs (similar to Applicant's therapist matching technology). The system can be used to increase the effectiveness of regional and national peer support teams which currently face barriers of geography and awareness of peer members.

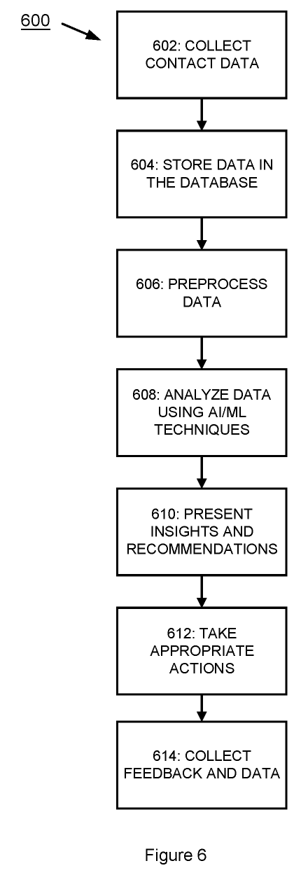

FIG. 6 illustrates the operation of the Organizational Team Management system according to an embodiment of the present disclosure. The process begins with the collection of contact data (step 602). Peer support team members input details about their interactions with organizational members through the Contact Management module 504, including the date, type of contact, reason for contact, and notes. The collected data is securely stored in the Database 508 (step 604), ensuring privacy and confidentiality.

The stored data undergoes preprocessing (step 606) to prepare it for analysis by the Al-powered Insights and Efficiency module 506. Data preprocessing techniques, such as data cleaning, normalization, and feature engineering, are applied to ensure data quality and compatibility with the AI/ML algorithms.

The preprocessed data is then analyzed using Al and ML techniques (step 608). The Al-powered Insights and Efficiency module 506 employs various algorithms, such as natural language processing (NLP), sentiment analysis, classification, and regression, to extract insights and generate recommendations. NLP and sentiment analysis are used to identify patterns, trends, and areas for improvement in the contact data. Classification and regression algorithms predict outcomes and suggest optimal support strategies based on historical data and learned patterns.

The generated insights and recommendations are presented to peer support team members through the Peer Support Dashboard 502 and the User Interface 510 (step 610). The dashboard provides an overview of peer support activities, highlighting key metrics, upcoming contacts, and personalized recommendations for each team member. The User Interface 510 allows peer support team members to view and act upon the insights and recommendations, enabling data-driven decision-making and optimized support strategies.

Based on the insights and recommendations, peer support team members can take appropriate actions (step 612) to enhance the effectiveness of their interactions with organizational members. This may include prioritizing high- risk cases, adapting support approaches, or leveraging best practice workflow templates provided by the system.

The system continuously collects feedback and data from peer support interactions (step 614), which is fed back into the Database 508. This feedback loop allows for the continuous improvement of the AI/ML models and the refinement of insights and recommendations over time.

The operation of the Organizational Team Management system, as described in FIG. 6, offers several benefits and advantages. By automating data collection and analysis, the system reduces manual effort and improves efficiency. The Al-powered insights and recommendations enable data-driven decision-making, allowing peer support team members to prioritize their efforts and adapt their strategies based on individual needs. The continuous feedback loop ensures that the system learns and improves over time, leading to more accurate and personalized support.

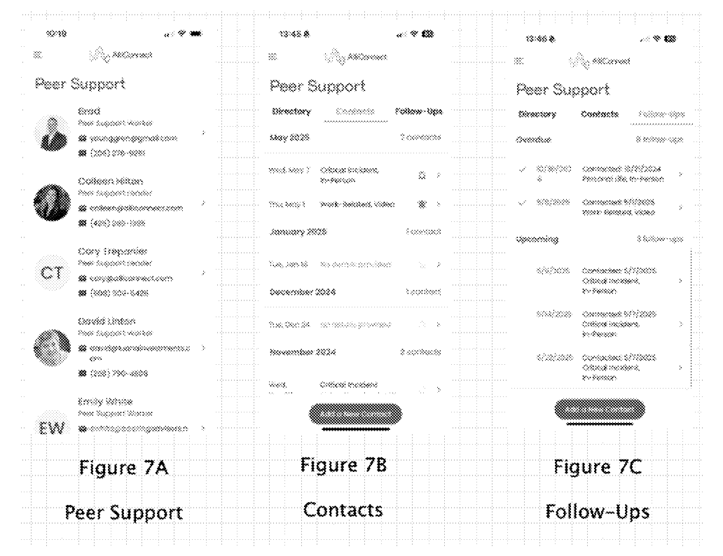

FIGS. 7A-3C illustrate example screenshots of the user interface of the Organizational Team Management system.

### Organizational Team Management Software and AI/ML Integration

The integration of software, Al, and ML technologies in the Organizational Team Management system represents an advancement in the field of peer support within organizations. By harnessing these technologies, the system empowers peer support teams to provide personalized, data-driven support, ultimately improving mental health outcomes and promoting well-being within the organization.

The Organizational Team Management (Peer Support) system leverages advanced software technologies, including artificial intelligence (AI) and machine learning (ML), to enhance the efficiency and effectiveness of peer support interactions within an organization. The system consists of several functional components that work together seamlessly to streamline processes, generate valuable insights, and optimize support strategies.

The Peer Support Dashboard (502) serves as a central hub for peer support team members to access an overview of their activities. By retrieving and displaying data from the database (508), the dashboard provides real-time information on the number of contacts per month, upcoming contacts, and featured self-help resources. This functionality enables peer support team members to efficiently track and organize their interactions with organizational members, ensuring timely follow-up and support.

The Contact Management module (504) is a crucial component of the system, allowing peer support team members to view, add, and manage contacts with organizational members. Through a user-friendly interface, team members can input contact details such as the date, type of contact, reason for contact, and notes. The Contact Management module securely stores this information in the database (508), facilitating the tracking and documentation of peer support interactions. By centralizing contact data, the system ensures proper follow-up and support, while maintaining the privacy and confidentiality of sensitive information.

One of the key innovations of the Organizational Team Management system is the integration of Al and ML techniques through the Al-powered Insights and Efficiency module (506). This module collects and analyzes contact data, including the type of contact, reason for contact, and notes, to extract valuable insights and optimize peer support processes. By employing natural language processing (NLP) and sentiment analysis, the system identifies patterns, trends, and areas for improvement in the contact data. This enables peer support teams to gain a deeper understanding of the needs and challenges faced by organizational members.

The Al-powered Insights and Efficiency module (506) utilizes supervised learning algorithms, such as classification and regression, to predict outcomes and recommend optimal support strategies. By training these algorithms on historical contact data and leveraging the power of machine learning, the system can identify high-priority cases and suggest personalized support approaches. This data-driven approach enhances the effectiveness of peer support by ensuring that resources are allocated efficiently and that organizational members receive the most appropriate and timely support.

To ensure the accuracy and reliability of the AI/ML models, the system employs robust data collection and preparation techniques. Contact data is collected through the Contact Management module (504), where peer support team members input details about their interactions with organizational members. This data is securely stored in the database (508), ensuring privacy and confidentiality.

Before feeding the data into the AI/ML algorithms, various data preprocessing techniques are applied. These techniques include data cleaning to handle missing values and remove duplicates, normalization to standardize data formats, and feature engineering to extract relevant features from the raw data. The preprocessed data is then split into training, validation, and testing sets to evaluate the performance and generalization of the AI/ML models. Techniques such as cross-validation and stratified sampling are employed to mitigate biases and ensure the representativeness of the training data.

By integrating software, Al, and ML technologies, the Organizational Team Management system enables data-driven decision-making and optimizes peer support processes. The system continuously learns and adapts based on the collected data, allowing it to refine its insights and recommendations over time. This iterative learning process ensures that the system remains up-to-date and responsive to the evolving needs of peer support teams and organizational members.

The Organizational Team Management system's software and AI/ML integration offers several key advantages. It automates data collection and analysis, reducing manual effort and improving efficiency. The Al-powered insights and recommendations enable peer support team members to prioritize their efforts, adapt support strategies based on individual needs, and leverage data-driven best practices. The system's ability to handle large-scale data and operate on a regional or national level makes it particularly valuable for organizations with geographically dispersed peer support teams.

### Organizational Team Management Data Engineering and ML Operations (ML OPS)

The Organizational Team Management system relies on robust data engineering and machine learning techniques to extract valuable insights and generate recommendations. The system collects contact data through the Contact Management module 504, where peer support team members input details about their interactions with organizational members. This data includes structured information, such as the date, type of contact, and reason for contact, as well as unstructured data in the form of notes and comments.

To ensure data quality and prepare the data for analysis, various data preprocessing techniques are applied. Data cleaning methods, such as handling missing values, removing duplicates, and standardizing formats, are employed to improve data consistency and reliability. Data normalization techniques, such as scaling and transforming variables, are used to ensure that the data is suitable for machine learning algorithms.

Feature engineering is performed to extract relevant features from the raw data that can provide meaningful insights. This may involve creating new features based on domain knowledge, such as categorizing contact types or extracting sentiment scores from notes using NLP techniques.

For supervised learning tasks, such as predicting outcomes or recommending support strategies, the preprocessed data is labeled with appropriate target variables. This labeled data is then split into training, validation, and testing sets to evaluate the performance and generalization of the AI/ML models. Techniques such as cross-validation and stratified sampling are employed to mitigate biases and ensure the representativeness of the training data.

The Al-powered Insights and Efficiency module 506 utilizes various machine learning algorithms to analyze the preprocessed and labeled data. Natural Language Processing (NLP) techniques, such as sentiment analysis and topic modeling, are applied to unstructured data to extract insights and identify patterns. Supervised learning algorithms, including classification and regression models, are trained on the labeled data to predict outcomes and recommend optimal support strategies.

The machine learning models are continuously evaluated and refined using techniques such as cross-validation and hyperparameter tuning. The system employs a feedback loop, where the predictions and recommendations are compared against actual outcomes, and the models are updated accordingly. This iterative process ensures that the AI/ML models improve over time, adapting to new data and evolving patterns.

The Organizational Team Management system also incorporates explainable Al techniques to provide transparency and interpretability of the Al-generated insights and recommendations. This allows peer support team members to understand the reasoning behind the system's suggestions and make informed decisions.

### Organizational Team Management Conclusion

The Organizational Team Management system for mental health represents a significant advancement in the field of peer support within organizations. By leveraging advanced technologies such as software, Al, and ML, the system streamlines peer support management, generates data-driven insights, and optimizes support strategies.

The system's architecture, including the Peer Support Dashboard 102, Contact Management module 504, Al-powered Insights and Efficiency module 506, Database 508, and User Interface 510, enables efficient tracking and management of peer support interactions. The integration of Al and ML techniques, such as natural language processing, sentiment analysis, and supervised learning algorithms, allows for the extraction of valuable insights and the generation of personalized recommendations.

The operation of the system, as described in FIG. 6, ensures a seamless flow of data collection, preprocessing, analysis, and feedback. The continuous feedback loop enables the system to learn and improve over time, adapting to the evolving needs of peer support teams and organizational members.

The Organizational Team Management system offers several key advantages over traditional methods. It enhances efficiency by automating data collection and analysis, reduces manual effort, and enables data-driven decision-making. The Al-powered insights and recommendations allow peer support team members to prioritize their efforts, adapt support strategies based on individual needs, and leverage best practice workflow templates.

Moreover, the system's ability to handle large-scale data and operate on a regional or national level makes it particularly valuable for organizations with geographically dispersed peer support teams. The secure and confidential handling of sensitive data ensures the privacy and trust of organizational members. In conclusion, the inventive system represents a transformative solution for enhancing the effectiveness and efficiency of peer support within organizations. By harnessing the power of software, Al, and ML, the system empowers peer support teams to provide personalized, data-driven support, ultimately improving mental health outcomes and promoting well-being within the organization.

### Digital Wellness Check Overview

The digital wellness check system represents a significant advancement in the field of mental health assessment by combining multiple evidence-based tools to provide a comprehensive and precise evaluation of an individual's psychological well-being. The system leverages technology to streamline the assessment process, reduce bias, and generate personalized recommendations based on the user's unique responses.

### Digital Wellness Check System Architecture

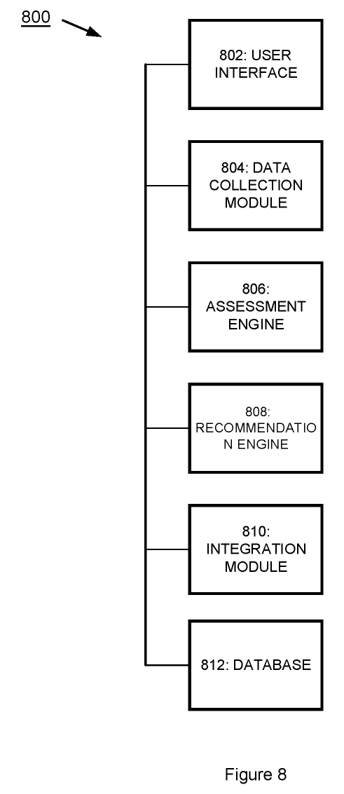

FIG. 8 illustrates the system architecture of the digital wellness check system 800 according to an embodiment of the present disclosure. The system 800 includes a user interface 802, a data collection module 804, an assessment engine 806, a recommendation engine 808, an integration module 810, and a database 812.

The user interface 802 enables users to interact with the digital wellness check system. It presents the assessment questions, collects user responses, and displays personalized recommendations. The user interface is designed to be accessible and user-friendly, ensuring a smooth and engaging experience for users across various devices, such as mobile phones, tablets, or computers.

The data collection module 804 is responsible for delivering the assessment instrument to users and collecting their responses. It manages the distribution of the assessment via email or text message, tracks completion status, and sends automated reminders to encourage participation. The data collection module ensures the confidentiality and security of user data throughout the process.

The assessment engine 806 analyzes the user's responses to the various PROMs and calculates a score based on predefined algorithms. It combines the results from the different assessment components to generate a comprehensive and precise evaluation of the user's mental health and wellness. The assessment engine considers the unique characteristics of each PROM and applies appropriate weighting and scoring mechanisms to produce accurate and reliable results.

The recommendation engine 808 utilizes the assessment results to generate personalized recommendations for each user. It considers the user's specific scores, identified areas of concern, and relevant demographic information to provide targeted suggestions for improving well-being. The recommendations may include lifestyle changes, stress management techniques, or resources for professional support. The recommendation engine aims to empower users with actionable insights and guidance tailored to their individual needs.

The integration module 810 enables the digital wellness check system to connect with external software systems, such as personnel software, records management systems, CAD, or medical records. It facilitates the exchange of data between the digital wellness check system and these external systems, allowing for seamless integration and automation of assessment triggers based on specific events or criteria. The integration module 810 also enables the feedback of assessment results into the external systems, ensuring compliance with organizational requirements and enabling a holistic approach to mental health management.

The database 812 serves as the central repository for storing user data, assessment results, and system configuration settings. It ensures the secure and confidential storage of sensitive information, adhering to strict data protection regulations. The database supports the aggregation and analysis of de-identified data, enabling the generation of valuable insights and trends at various levels, such as organization, geography, gender, age, or profession.

### Digital Wellness Check Operation

As discussed below, in the illustrative embodiment, the inventive digital wellness assessment combines 6 evidence-based outcomes measures (or patient reported outcomes measures, PROMs) that are open source and clinically validated in their individual areas, to create a more global and precise assessment of psychological health and wellness.

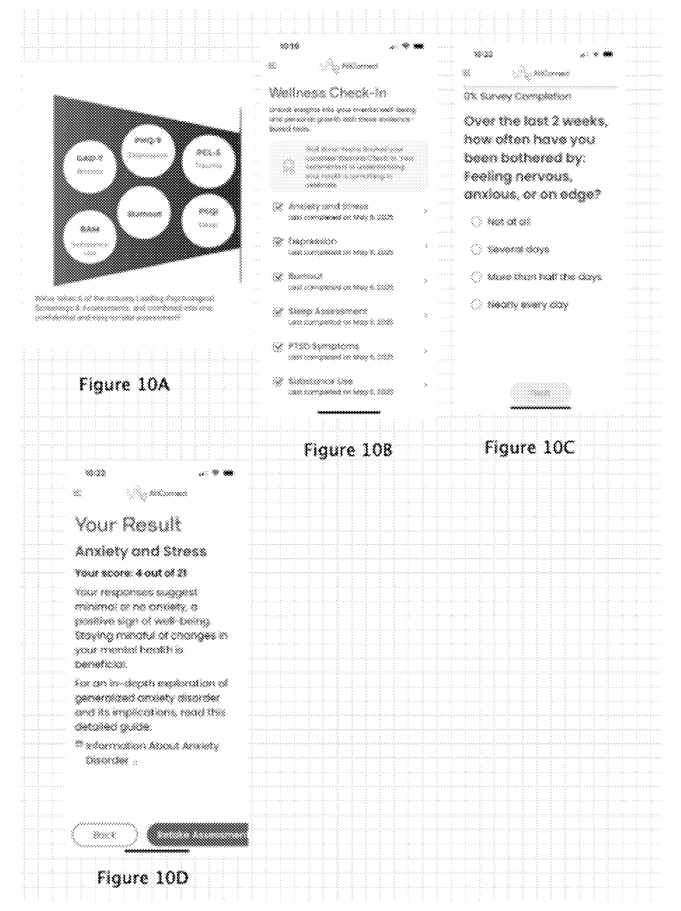

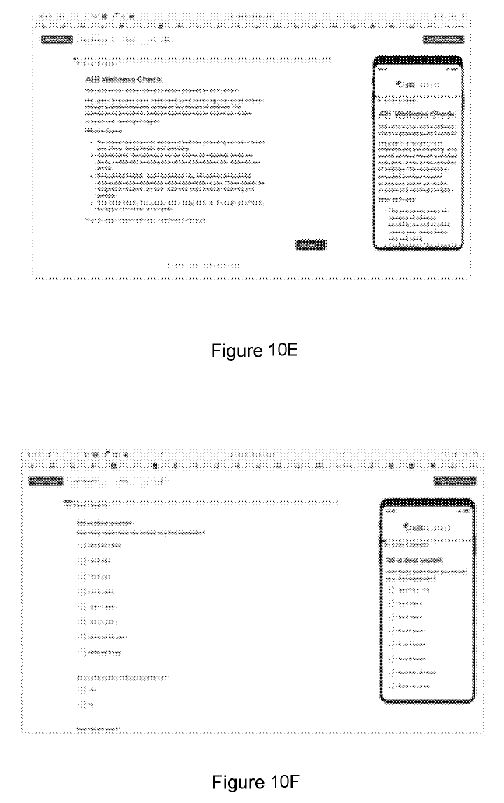

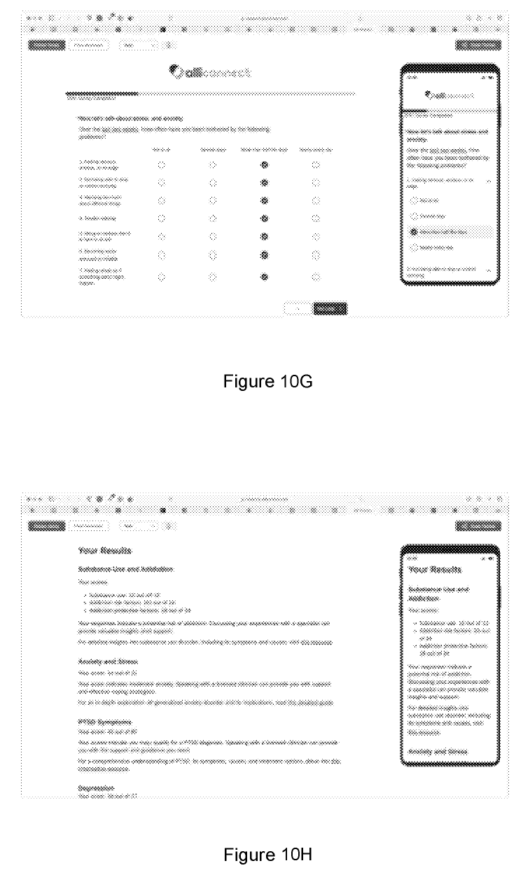

PROMs currently include the 6 pictured in FIG. 10A. The assessment is deployed to a user via email and/or text message and the user walks through a digital experiences of the PROMs. Upon completion, the software calculates the 'score' and produces both a quantitative and qualitative result with a recommendation for next steps customized to the result of that patient's assessment. Individual results can be aggregated by groups (organization, geography, gender, age, profession, etc.) to provide trend data. Aggregate results are de-identified for individual privacy. 'At risk' individuals can be escalated to receive a suicide risk assessment digitally, or flagged for human intervention. The tool can be taken numerous times, and in a gamified manner to allow for results that produce trend information for that individual.

This tool can be used and connected to other software systems (personnel software, records management, CAD, medical records, etc.) as an action item for patients following a trigger in this other system. Results can also feed back into other systems to ensure compliance needs are met.

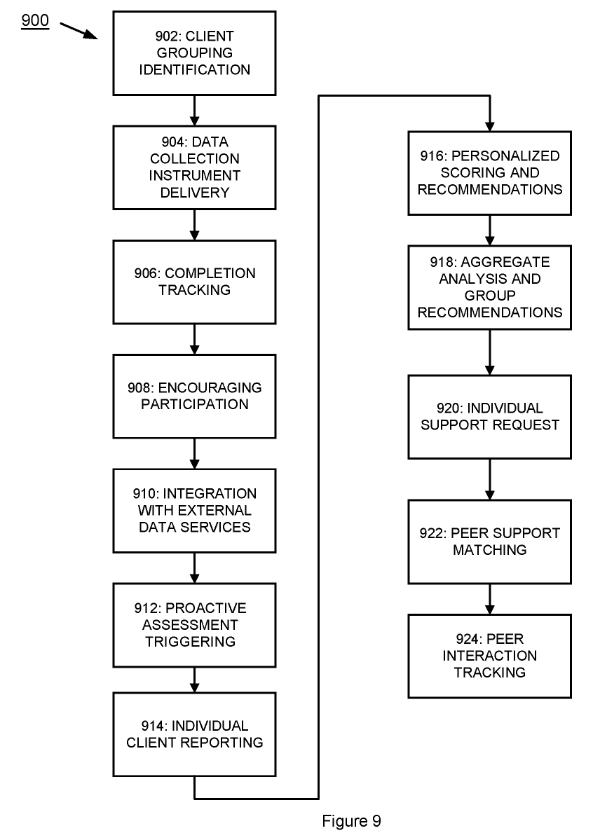

FIG. 9 illustrates the operation of the digital wellness check system according to an embodiment. The process begins with client grouping identification (step 902), where the system categorizes users into relevant groups based on factors such as department, job role, location, or other organization-specific criteria. This step allows for a tailored approach to wellness assessment and intervention, ensuring that the assessments are targeted and relevant to each group's unique needs.

Next, the data collection instrument is delivered to each user within the identified client groupings (step 904). The assessment is sent via email, text message, and/or push notification providing a convenient and accessible means for users to participate. The system tracks the completion status of each user (step 906) and sends automated reminders and personalized prompts to encourage participation (step 908). This ensures a high response rate and enables the organization to gather comprehensive data for analysis.

The digital wellness check system also integrates with external data services (step 910) to proactively trigger assessments based on relevant events or information. By leveraging Al and advanced filtering techniques, the system can monitor data from sources such as first responder records management systems, news feeds, or other relevant outlets. When a significant event or situation is identified that may impact the well-being of specific client groupings, the system automatically sends out the assessment to the affected individuals (step 912). This proactive approach allows for timely evaluation of their wellness in the moment, enabling the organization to provide immediate support and interventions as needed.

As users complete the assessment, their responses are securely submitted (step 914), and the system generates personalized scoring and recommendations for each individual (step 916). The scoring algorithm considers the unique responses and measurements provided by each user, offering tailored insights and actionable suggestions for improving their well- being. These recommendations may include lifestyle changes, stress management techniques, or resources for professional support.

In addition to individual-level analysis, the digital wellness check system performs aggregate scoring and generates recommendations for the entire group (step 918). This holistic view allows organizations to identify overarching trends, common challenges, and areas of strength within the workforce. The aggregate analysis provides valuable insights for developing targeted wellness programs, policies, and initiatives that address the specific needs of the organization.

The system also includes a feature for individual users to request a contact of support (step 920). Using advanced matching technology, like therapist matching systems, the user is paired with the most suitable peer support team member based on their unique needs and preferences (step 922). This ensures that users receive personalized support and guidance from someone who understands their situation and can provide effective assistance.

The digital wellness check system offers a streamlined and confidential way for peer support teams to track their interactions with users (step 924). Relevant data, such as the number and type of interactions, is securely stored in the database 812, allowing for quantitative analysis of the effectiveness of peer support efforts at both individual and team levels. This data-driven approach enables organizations to optimize their peer support programs and allocate resources effectively.

Throughout the process, the digital wellness check system 800 maintains the confidentiality and privacy of user data. All information is securely stored in the database 812, and any data aggregation or analysis is performed using de- identified data to protect individual privacy.

FIGS. 10A-10H depict screenshots of the user interface of the digital wellness check system, illustrating the various PROMs and assessment components.

FIG. 10A shows the main dashboard of the digital wellness check system, presenting an overview of the available PROMs. The dashboard displays six evidence-based PROMs, including the Patient Health Questionnaire (PHQ-9), Generalized Anxiety Disorder Assessment (GAD-7), Primary Care PTSD Screen for DSM-5 (PC-PTSD-5), Sleep Quality Scale, Alcohol Use Disorders Identification Test (AUDIT-C), and Perceived Stress Scale (PSS).

FIG. 10B illustrates the user interface for the Patient Health Questionnaire (PHQ-9). The PHQ-9 assesses the severity of depression symptoms experienced by the user over the past two weeks. The screenshot shows the nine questions of the PHQ-9, along with the response options for each question.

FIG. 10C presents the user interface for the Primary Care PTSD Screen for DSM-5 (PC-PTSD-5). The PC-PTSD-5 screens for the presence of post- traumatic stress disorder (PTSD) symptoms. The screenshot shows the five questions of the PC-PTSD-5, along with the binary response options (yes/no) for each question.

FIG. 10D illustrates the user interface for the Sleep Quality Scale. This scale assesses the user's sleep quality over the past month. The screenshot displays the questions related to sleep duration, latency, efficiency, disturbances, use of sleep medication, and daytime dysfunction, along with the corresponding response options.

FIG. 10E depicts the user interface for the Generalized Anxiety Disorder Assessment (GAD-7). The GAD-7 evaluates the severity of anxiety symptoms experienced by the user over the past two weeks. The screenshot displays the seven questions of the GAD-7, along with the response options for each question.

FIG. 10F depicts the user interface for the Alcohol Use Disorders Identification Test (AUDIT-C). The AUDIT-C screens for hazardous alcohol consumption. The screenshot shows the three questions of the AUDIT-C, which assess the frequency and quantity of alcohol intake, along with the response options for each question.

FIG. 10G presents the user interface for the Perceived Stress Scale (PSS). The PSS measures the user's perception of stress over the past month. The screenshot displays the ten questions of the PSS, which evaluate the frequency of stress-related thoughts and feelings, along with the response options for each question.

FIG. 10H shows the results page of the digital wellness check system. The screenshot illustrates how the system presents the user's assessment scores for each PROM, along with personalized recommendations based on the results. The recommendations may include lifestyle changes, stress management techniques, or resources for professional support tailored to the individual's specific needs.

These descriptions provide an overview of the user interface and functionality of the digital wellness check system, as depicted in FIGS. 10A-10H. The screenshots showcase the seamless integration of multiple evidence-based PROMs into a comprehensive assessment tool, highlighting the system's ability to generate personalized insights and recommendations based on the user's responses.

### Digital Wellness Check Software and AI/ML

The software and AI/ML components of the digital wellness check system play a vital role in automating and optimizing various stages of the assessment process. By leveraging advanced technologies, the system delivers personalized insights, proactive interventions, and data-driven recommendations that support the well-being of individuals and organizations. The continuous learning and improvement capabilities of the Al and ML algorithms ensure that the system remains at the forefront of mental health assessment and support, adapting to the changing needs of its users over time.

The digital wellness check system leverages advanced software technologies, including artificial intelligence (AI) and machine learning (ML), to enhance the accuracy, efficiency, and personalization of the assessment process. The software components play a crucial role in various stages of the system's operation, from client grouping identification to personalized recommendations and aggregate analysis.

### Client Grouping Identification

The system employs Al algorithms to automatically identify and categorize client groupings within the organization. These algorithms analyze various data points, such as department, job role, location, and other relevant criteria, to create meaningful clusters of individuals with similar characteristics. The Al- driven client grouping ensures that the assessments are tailored to the specific needs and contexts of each group, enabling more targeted interventions and support.

### Data Collection Instrument Delivery

The software component responsible for delivering the data collection instrument is designed to be highly accessible and user-friendly. It leverages responsive web design principles and cross-platform compatibility to ensure that the assessment can be easily completed on various devices, including mobile phones, tablets, and computers. The intuitive user interface and clear instructions guide participants through the assessment process, reducing confusion and increasing completion rates.

### Integration with External Data Services

The digital wellness check system incorporates advanced Al and ML techniques to integrate with external data services and proactively trigger assessments based on relevant events or information. The software continuously monitors and analyzes data from various sources, such as first responder records management systems, news feeds, and other relevant outlets. Sophisticated natural language processing (NLP) algorithms are employed to extract meaningful insights from unstructured text data, identifying potential triggers for assessment deployment.

The Al component utilizes machine learning models trained on historical data to predict the likelihood of a significant event impacting the well-being of specific client groupings. When a trigger is identified, the system automatically sends out the assessment to the affected individuals, ensuring timely evaluation and support. The ML models continuously learn from the outcomes of previous assessments and interventions, refining their predictive capabilities over time.

### Personalized Scoring and Recommendations

The software component responsible for generating personalized scoring and recommendations leverages Al and ML algorithms to analyze individual responses and provide tailored insights. The system utilizes a combination of rule-based and data-driven approaches to interpret the assessment results and generate meaningful recommendations.

The Al algorithms consider various factors, such as the individual's responses, demographic information, and historical data, to identify patterns and correlations that inform the personalized recommendations. Machine learning models, trained on large datasets of previous assessments and outcomes, continuously refine their predictive capabilities, enabling more accurate and relevant suggestions for each individual.

### Aggregate Analysis and Group Recommendations

The software component that performs aggregate analysis and generates group recommendations employs advanced statistical techniques and machine learning algorithms to identify trends, patterns, and correlations within the collective assessment data. The system analyzes the de-identified responses across different client groupings, considering factors such as department, job role, location, and other relevant criteria.

The Al algorithms utilize clustering and classification techniques to identify common challenges, strengths, and areas for improvement within each group. The insights derived from the aggregate analysis inform the development of targeted wellness programs, policies, and initiatives that address the specific needs of the organization as a whole.

The machine learning models continuously learn from the outcomes of previous interventions and initiatives, refining their predictive capabilities and enabling more effective group recommendations over time. The system also employs sentiment analysis and topic modeling techniques to extract meaningful themes and sentiments from open-ended responses, providing a deeper understanding of the group's well-being.

### Data Privacy and Security

The digital wellness check system prioritizes data privacy and security throughout its operation. All data collected through the assessments is encrypted and stored securely in compliance with relevant regulations and industry standards. The software components employ advanced security measures, such as secure communication protocols, access controls, and data anonymization techniques, to protect sensitive information.

The Al and ML algorithms operate on de-identified data, ensuring that individual privacy is maintained during the analysis and recommendation generation process. The system also includes robust data governance mechanisms, such as data access controls and audit trails, to maintain the integrity and confidentiality of the assessment data.

### Continuous Improvement

The digital wellness check system is designed to continuously improve its performance and adapt to the evolving needs of organizations and individuals. The Al and ML components are regularly updated with new data and feedback, enabling the system to learn from its experiences and refine its algorithms over time.

The software undergoes rigorous testing and validation processes to ensure the accuracy and reliability of the assessments, recommendations, and aggregate insights. Regular updates and enhancements are deployed to incorporate the latest advancements in Al and ML, as well as to address any identified issues or areas for improvement.

### Digital Wellness Check Conclusion

The digital wellness check system represents a transformative solution for mental health assessment, offering a unique combination of accuracy, efficiency, and comprehensiveness. By leveraging advanced software technologies and evidence-based PROMs, the system empowers individuals and organizations to prioritize mental health and take proactive steps towards improving well-being. As the importance of mental health continues to gain recognition, the digital wellness check system sets a new standard for assessment and support, paving the way for a healthier and more resilient future.

The inventive system offers a novel and comprehensive approach to evaluating and supporting individual well-being. By combining multiple evidence-based PROMs into a seamless software solution, the system provides a highly accurate and precise assessment of an individual's mental health, enabling organizations to identify potential risks and provide targeted interventions.

The system's innovative features, such as the ability to complete assessments in a safe and non-medical environment, significantly reduce outside influence and bias in reporting. This ensures that the collected data accurately reflects the individual's true mental state, leading to more reliable and actionable insights. The personalized recommendations generated by the system empower individuals to take proactive steps towards improving their well-being, promoting a culture of self-care and resilience.

Moreover, the digital wellness check system offers unparalleled efficiency and scalability compared to prior existing technology. By automating the assessment process through advanced software, the system drastically reduces the time and resources required for execution. This increased efficiency enables organizations to assess the mental health of large populations quickly and cost-effectively, ensuring that timely support can be provided to those in need.

The unique combination of PROMs within the digital wellness check system provides a holistic assessment that encompasses both psychological and physiological indicators of stress. This comprehensive approach allows organizations to gain a deeper understanding of the factors contributing to an individual's mental health, facilitating the development of targeted interventions and support strategies. By addressing the specific needs of their members, organizations can foster a culture of well-being and resilience, ultimately leading to improved productivity, job satisfaction, and overall quality of life.

The system's advanced software capabilities, such as seamless integration with existing systems and automated assessment triggers, ensure that the system is fully aligned with organizational needs. This integration enables real- time insights and recommendations, allowing organizations to respond promptly to potential mental health concerns and provide immediate support to individuals in need.

The invention illustratively disclosed herein suitably may explicitly be practiced in the absence of any element which is not specifically disclosed herein. While various embodiments of the present invention have been described in detail, it is apparent that various modifications and alterations of those embodiments will occur to and be readily apparent those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. The present disclosure also contemplates other embodiments "comprising," "consisting of" and "consisting essentially of," the embodiments or elements presented herein, whether explicitly set forth or not. In addition, it is to be understood that the phraseology and terminology used herein is for the purpose of description and should not be regarded as limiting. The use of "including," "comprising," or "having" and variations thereof herein is meant to encompass the items listed thereafter and equivalents thereof as well as additional items, while only the terms "consisting of' and "consisting only of' are to be construed in the limitative sense.

1. A computer-implemented patient-provider matching system, comprising:
a therapist user interface configured to collect provider data including logistical factors, clinical specializations, and human factors;
a client user interface configured to collect patient preferences across logistical, clinical, and human factor categories;
a database storing patient and provider profiles;
a client-therapist matcher employing an AI algorithm to generate matches by analyzing prioritized patient preferences against provider data, wherein the algorithm iteratively improves via machine learning based on patient feedback and observed engagement metrics; and
a notification API facilitating asynchronous communication between matched patients and providers.

2. The system of claim 1, wherein the logistical factors include geolocation constraints and appointment availability derived from provider calendars.

3. The system of claim 1, wherein the human factors include therapist gender preference and lived-experience alignment indicators.

4. The system of claim 1, wherein the client user interface includes a priority selection screen allowing patients to rank factors in order of importance using an interactive interface.

5. The system of claim 1, wherein the clinical specializations include treatment modalities and expertise in specific mental health conditions presented in a specialty selection screen.

6. The system of claim 1, wherein the client user interface displays a therapist recommendation screen showing ranked provider matches with detailed profile information.

7. A computer-implemented method for matching patients with mental health providers, comprising:
collecting patient preference data via a client UI, including prioritization of logistical, clinical, and human factors using a drag-and-drop interface;
storing provider profiles in a database, the profiles including therapeutic style metadata and cultural competency indicators;
executing an AI matching algorithm to generate ranked provider recommendations by weighting patient-prioritized factors against provider data;
transmitting match notifications via a messaging API; and
updating the AI algorithm using feedback from patient-provider interaction patterns.

8. The method of claim 7, further comprising tracking patient in-app behavior to validate matches, including session frequency and message response times.

9. The method of claim 7, further comprising enabling patients to select a specific therapy type during preference collection via a therapy type selection screen.

10. The method of claim 7, further comprising implementing a specialized interface for first responder users with additional profession-specific factors integrated into the matching algorithm.

11. The method of claim 7, further comprising enabling providers to accept or decline patient matching requests, and initiating human navigation assistance when a provider declines a patient referral.

12. The method of claim 7, wherein the provider profiles include cultural competency indicators enabling matches based on cultural alignment preferences.

13. A computer-implemented organizational team management system for mental health support comprising:
a contact management module configured to track peer support interactions through user-generated input fields including contact type, reason codes, and free-form notes;
an AI insights module implementing natural language processing (NLP) and sentiment analysis on interaction data to generate mental health risk assessments;
a secure encrypted database storing de-identified interaction records and organizational member profiles;
a dashboard interface displaying real-time metrics of support team performance and prioritized intervention recommendations.

14. The system of claim 13, wherein the AI insights module employs supervised machine learning classifiers trained on historical interaction outcomes to predict optimal support strategies.

15. The system of claim 13, further comprising clinical workflow templates guiding peer supporters through evidence-based intervention sequences.

16. The system of claim 13, wherein the contact management module includes geolocation tracking to coordinate regional support teams.

17. The system of claim 13, further comprising an automated matching engine pairing organizational members with peer supporters based on recorded needs.

18. The system of claim 13, wherein the dashboard (102) displays aggregated mental health trend analytics across predefined organizational subgroups.

19. The system of claim 13, wherein the AI insights module generates real-time sentiment trajectory visualizations during active support sessions.

20. A computer-implemented method for managing organizational peer support teams comprising:
collecting structured interaction data through a contact management interface;
preprocessing interaction notes using tokenization and entity recognition;
applying ensemble machine learning models to predict mental health outcomes;
generating adaptive workflow recommendations through a clinical decision support system;
continuously updating prediction models via feedback loops from intervention outcomes.

21. The method of claim 20, further comprising clustering organizational members into risk cohorts using unsupervised learning on interaction patterns.

22. The method of claim 20, wherein preprocessing includes calculating sentiment polarity scores for free-form notes using lexicon-based analysis.

23. The method of claim 20, further comprising employing differential privacy techniques when aggregating data across organizational subunits.

24. The method of claim 20, further comprising automatically triggering crisis alerts when detecting acute risk factors through multi-modal data fusion.

25. The method of claim 20, further comprising optimizing peer supporter workloads using reinforcement learning-based scheduling algorithms.

26. The method of claim 20, implementing blockchain-based audit trails for all data modifications in the encrypted database.

27. A computer-implemented mental health assessment system, comprising:
a user interface configured to deliver a plurality of validated patient-reported outcome measures (PROMs) via digital distribution channels;
a data collection module programmed to aggregate user responses from said PROMs, wherein the PROMs include at least six distinct psychological assessment tools selected from: PHQ-9, GAD-7, PC-PTSD-5, Sleep Quality Scale, AUDIT-C, and Perceived Stress Scale;
an assessment engine utilizing machine learning algorithms to generate (i) a composite mental health score weighted across said PROMs and (ii) qualitative insights identifying specific risk domains;
a recommendation engine dynamically producing personalized intervention strategies based on said composite score and risk domains;
an integration module interfacing with external enterprise software systems to automatically trigger assessments in response to predefined organizational events.

28. The system of claim 27, wherein said integration module triggers assessments based on real-time analysis of external data streams comprising first responder dispatch records or public health alerts.

29. The system of claim 27, wherein the machine learning algorithms incorporate temporal pattern recognition to detect longitudinal changes in user responses across repeated assessments.

30. The system of claim 27, further comprising gamification elements tracking user progress through sequential assessments to incentivize participation.

31. The system of claim 27, wherein the recommendation engine outputs clinician-facing alerts and patient-facing resources simultaneously through distinct communication channels.

32. The system of claim 27, wherein the external enterprise software systems include computer-aided dispatch (CAD) or electronic medical record (EMR) platforms.

33. A method for digital mental health evaluation, comprising:
classifying users into client groupings based on organizational role parameters using AI clustering algorithms;
deploying a digital assessment combining six evidence-based PROMs through secure mobile/web interfaces;
applying predictive analytics to user responses to identify at-risk individuals requiring suicide risk escalation protocols;
generating de-identified aggregate trend data across demographic cohorts while preserving individual privacy;
synchronizing assessment results with external records management systems via API connections;
initiating automated peer-support matching when composite scores exceed clinically validated thresholds.

34. The method of claim 33, wherein the AI clustering algorithms prioritize geographic proximity and job function similarity when classifying client groupings.

35. The method of claim 33, further comprising natural language processing (NLP) analysis of free-text user feedback accompanying PROM responses.

36. The method of claim 33, wherein the suicide risk escalation protocols include (a) automated crisis hotline routing and (b) biometric authentication for emergency service access.

37. The method of claim 33, wherein the API connections enforce HIPAA-compliant data anonymization prior to external system integration.

38. The method of claim 33, wherein the peer-support matching utilizes neural networks trained on historical intervention success patterns.
